(19) United States
(12) Patent Application Publication
(10) Pub. No.: US 2024/0108922 A1
(43) Pub. Date: Apr. 4, 2024

(54) A Facial Mask Assembly Dispensing a Protective Laminar Airflow

(71) Applicant: UNIVERSITÉ LAVAL, Quebec (CA)

(72) Inventors: Amine Miled, Quebec (CA); Hamza Landari, Quebec (CA)

(21) Appl. No.: 18/276,598

(22) PCT Filed: Feb. 10, 2022
(86) PCT No.: PCT/CA2022/050196

§ 371 Date: Aug. 9, 2023

Related U.S. Application Data
(60) Provisional application No. 63/147,905, filed on Feb. 10, 2021.

(51) Int. Cl. A62B 18/02; A62B 18/00; A62B 18/08; A62B 18/10; A62B 23/02

(52) U.S. Cl. CPC A62B 18/025; A62B 18/006; A62B 18/08; A62B 18/10; A62B 23/02

(57) ABSTRACT

A facial mask assembly and related method for preventing exposure of a user's face to ambient air contaminants via aerosol by dispensing at least one laminar airflow serving as a face air shield, and another airflow to naso-buccal passages of the user via an air chamber. The at least on laminar airflow is formed along a deflecting lip at a given angle, with the deflecting lip extending from an edge of a main component of the facial mask assembly that covers the naso-buccal passages and defines the air chamber. The assembly can further include a deflection wall that dispenses a secondary laminar airflow and directs expelled air from the assembly between the laminar airflow and the secondary laminar airflow.

### CROSS-REFERENCE TO RELATED APPLICATIONS

This application is the United States national phase of International Application No. PCT/CA2022/050196 filed Feb. 10, 2022, and claims priority to U.S. Provisional Patent Application No. 63/147,905 filed Feb. 10, 2021, the disclosures of each of which are hereby incorporated by reference in their entireties.

### BACKGROUND OF THE INVENTION

### Field of the Invention

The present techniques generally relate to personal protective equipment, specifically to a respiratory facial mask and, more particularly, to a facial mask assembly including at least one deflecting air path that generates a laminar airflow acting as a face shield.

### Description of Related Art

Prevention of exposure to contaminants via aerosols, droplets, or fomites can involve the use of respiratory facial masks covering at least one of the buccal region, nasal region, and ocular region.

In an effort to protect all of these regions, multiple mask designs have been developed. Complex design can render the use of the mask impractical, the cleaning of mask component difficult, and the comfort for the user minimal. When covering the ocular region with a facial mask or with goggles, an undesired fogging of the components can further reduce the visibility.

Various challenges related to the design and use of facial mask assemblies remain to be overcome.

### SUMMARY OF THE INVENTION

In one aspect, there is provided a facial mask assembly positionable to cover naso-buccal passages of a user. The facial mask assembly defines a deflecting air path receiving a first body of air, and the deflecting air path is configured to convert the first body of air into a laminar airflow, thereby forming an air shield to uncovered face regions. The facial mask assembly further defines an air chamber in fluid communication with the naso-buccal passages and being supplied with a second body of air.

The facial mask assembly includes a main hull positionable to cover the naso-buccal passages and the main hull includes:
a main component having a cup-like shape and defining the air chamber in fluid communication with the naso-buccal passages, and
a deflecting lip extending outwardly from an end portion of the main component and being tapered at a given angle.

The facial mask assembly further includes an inlet unit including:
a first air inlet in fluid communication with the deflecting lip to provide the first body of air thereto at a first inlet flowrate, and
a second air inlet in fluid communication with the air chamber to provide the second body of air therein for supply to the naso-buccal passages at a second inlet flowrate.

The facial mask assembly further includes an outlet unit comprising an air outlet defined in the main hull and being in fluid communication with the air chamber to expel air from the air chamber.

The first body of air is communicated to the deflecting lip and is further converted into the laminar airflow upon being deflected at the given angle by the deflecting lip. The laminar airflow flows away from the deflecting lip to form an air shield to the uncovered face regions.

In some implementations of the assembly, the deflecting lip extends from an upper end region of the main component so that the resulting laminar airflow protects at least an ocular region of the uncovered face regions. For example, the deflecting lip can extend from a side end region of the main component so that the resulting laminar airflow protects an auricular region of the uncovered face regions. Optionally, the deflecting lip can extend from a lower end region of the main component so that the resulting laminar airflow protects a cervical region of the uncovered face regions. Further optionally, the deflecting lip can be defined by multiple lip portions, each lip portion being tapered differently from an adjacent lip portion.

In some implementations of the assembly, the assembly further includes an outer hull providing coverage to the main hull and being operatively connected to the main component of the main hull to define a gap there between. The first body of air can be supplied to the gap via the first air inlet and further flows along the gap to the deflecting lip to generate the laminar airflow. For example, the gap between the main hull and the outer hull can be between 1 mm and 10 mm. Optionally, the width of the gap can be selected/adjusted to provide a laminar flowrate of at least 0.1 L/min.

In some implementations of the assembly, the assembly further includes an adjustment mechanism allowing the outer hull to move with respect to the main hull so as to vary the width of the gap. For example, the adjustment mechanism can include a screw and hole system, or a bolt and nut system.

In some implementations of the assembly, the assembly further includes a connection mechanism that operatively connects the outer hull to the main hull in a spaced-apart relationship. For example, the connection mechanism can include a protrusion that is extending from the outer hull and insertable in an aperture or a cavity of the main hull.

In some implementations of the assembly, the outlet unit further includes an outer air outlet being defined as at least one aperture in the outer hull. The air outlet is in fluid communication with the outlet air outlet to expel air from the air chamber.

In some implementations of the assembly, the main hull further includes a protrusion extending inwardly from the main component of the main hull and towards the naso-buccal passages to define a cavity. The air outlet of the main hull can include multiple inner apertures defined in a proximal surface of the protrusion.

In some implementations of the assembly, the assembly further includes a connection mechanism that operatively connects the outer hull to the main hull in a spaced-apart relationship, with the connection mechanism cooperating with the outlet unit to prevent air from the air chamber to be communicated to the gap between the main hull and outer hull. For example, the connection mechanism can include a plug connector being sized and shaped to be inserted in the outer air outlet of the outer hull, and to be further engaged within the cavity defined by the protrusion of the main hull. Optionally, the outlet unit can further include multiple apertures defined in a distal surface of the plug connector.

In some implementations of the assembly, the first air inlet can be a first aperture defined in a lower region of the outer hull to feed the first body of air to the gap between the main hull and the outer hull; and the second inlet can be a second aperture defined in a lower region of the main hull to feed the second body of air to the air chamber.

In another embodiment of the assembly, the main hull can be configured to define multiple hollow channels extending within the main hull from the first air inlet to a base of the deflecting lip for guiding the first body of air. For example, each channel can have an average diameter/dimension between 0.1 mm and 10 mm, for example between 2 mm and 5 mm.

In some implementations of the assembly, the first air inlet can be a first aperture defined in a lower region of the main hull to feed the first body of air to the multiple channels; and the second inlet can be a second aperture defined in the lower region of the main hull to feed the second body of air to the air chamber.

In some implementations of the assembly, the inlet unit can further include:
a first tubular connector that is connected to the first air inlet; and
a second tubular connector that is connected to the second air inlet;
wherein the first tubular connector and the second tubular connector are connectable to the air source to provide the first body of air and second body of air respectively.

Optionally, the first tubular connector and the second tubular connector can be independently connectable to an air source via two separate tubing lines. Further optionally, the first tubular connector and the second tubular connector can be connectable to an air source via a main tubing line receiving air flowing from the air source.

In another embodiment of the assembly, the assembly can include multiple blowing chambers that are distributed over a surface of the main hull, each blowing chamber having an outlet located proximal to a base of the deflecting lip and having an inlet encasing a fan that is actuable to make a portion of the first body of air flow through the blowing chamber at the first inlet flowrate.

In some implementations of the assembly, the first air inlet of the inlet unit can be defined by the multiple inlets of the blowing chambers, each blowing chamber providing the portion of the first body of air to the deflecting lip to generate the laminar airflow.

In some implementations of the assembly, the assembly can include a controller unit to adjust at least one of the first inlet flowrate and the second inlet flowrate. Optionally, the controller unit can further include at least one flowmeter that monitors a flowrate of at least one of the air expelled from the air chamber and the laminar airflow.

In some implementations of the assembly, the second inlet flowrate can be lower than the first inlet flowrate.

In some implementations of the assembly, the assembly can further include a sealing member that is secured to a circumference of the main hull and ensuring sealing of the air chamber when the main hull is positioned to cover the naso-buccal passages. For example, the sealing member can be glued to the circumference of the main hull. Optionally, the sealing member can be made of medical-grade silicon.

In some implementations of the assembly, the assembly can further include a flow control component that is operatively connected to the main hull and located within the air chamber to create a local flow resistance to the incoming second body of air in a lower region of the air chamber, thereby guiding the second body of air mainly towards nasal passages. Optionally, the flow control component can include a frusto-conically shaped member having a plurality of openings. For example, the plurality of openings can include a primary opening that is sized to accommodate a nasal region, and multiple smaller secondary openings. Optionally, the flow control component can further include a plurality of elongated projections extending from the frusto-conically shaped member towards the main hull so as to serve as spacers between the main hull and the flow control component. Further optionally, the main hull can further include a plurality of tubular protrusions extending from the main component and towards the flow control component so as to engage the elongated projections.

In some implementations of the assembly, the inlet unit can further include a filtering membrane to remove contaminants from at least one of the first body of air and the second body of air.

In some implementations of the assembly, the main hull can include two opposite anchor members extending from each side of the main component, and offering anchorage to a strap component for securing the facial mask assembly to a head region. For example, each anchor member can define a loop for insertion of the strap component there through.

In some implementations of the assembly, the assembly can further include a deflection wall that extends outwardly and upwardly to convert a third body of air into a secondary laminar airflow along an upper region of the facial mask assembly, thereby directing air expelled from the air chamber between two laminar airflows. For example, the third body of air can be a portion of the first body of air that is bypassed from the first air inlet to the deflecting wall. In another example, the inlet unit can include a third air inlet in fluid communication with the deflecting wall to generate the secondary laminar airflow separately from the first body of air generating the laminar airflow from the deflecting lip. Optionally, the third body of air is fed to the third air inlet at a third inlet flowrate of at least 0.1 L/min.

In some implementations of the assembly, the first body of air is fed via the first air inlet at the first inlet flowrate that can be adjusted to provide a laminar flowrate of at least 0.1 L/min.

In some implementations of the assembly, the outlet unit further can include a one-way valve allowing air from the air chamber to be expelled towards the outside of the mask assembly via the at least one air outlet, and preventing air from entering the air chamber via the at least one air outlet.

In another aspect, there is provided a method to prevent exposure of a user's face to ambient air contaminants via aerosol, droplets or fomites. The method includes:
providing a first airflow and a second airflow;
covering naso-buccal passages of the face to create an air chamber preventing ambient air contaminants from entering the naso-buccal passages, thereby leaving uncovered face regions exposed to ambient air;
deflecting the first airflow at a given angle for converting the first airflow into a laminar airflow, thereby forming an air shield to at least some of the uncovered face regions; and
supplying the second airflow to the naso-buccal passages via the air chamber.

In some implementations of the method, deflecting the first airflow at the given angle can include supplying the first airflow to a deflecting path at a first inlet flowrate via a first air inlet, the deflecting path being defined by a gap between a main hull and an outer hull, and by a deflecting lip extending at the given angle from a main component of the main hull above an outlet of the gap.

In other implementations of the method, deflecting the first airflow at the given angle can include supplying the first airflow to a deflecting path at a first inlet flowrate via a first air inlet, the deflecting path being defined by multiple channels provided within a main hull, and by a deflecting lip extending at the given angle from a main component of the main hull above an outlet of the multiple channels.

In some other implementations of the method, deflecting the first airflow at the given angle can include supplying the first airflow to a deflecting path at a first inlet flowrate, the deflecting path being defined by multiple blowing chambers provided over a surface of the main hull, and by a deflecting lip extending at the given angle from a main component of the main hull above an outlet of the blowing chambers. Each blowing chamber can include a fan, and supplying the first airflow to the deflecting path comprises actuating the fan of each blowing chamber to generate the first airflow from ambient air.

Optionally, supplying the first airflow to the deflecting path can include connecting the first air inlet to an air source.

Optionally, supplying the second airflow to the naso-buccal passages comprises supplying the second airflow to the air chamber via a second air inlet in fluid communication with the air chamber. For example, supplying the second airflow to the air chamber can include connecting the second inlet channel to an air source.

In some implementations of the method, the air source can be a portable device that generates the first and second airflows. For example, the air source can generate purified and sterile air or mixture of gases safe for humans.

In some implementations of the method, the method can further include filtering at least one of the first airflow and second airflow to remove any contaminants therefrom.

In some implementations of the method, the method can include modifying a geometry of the defecting path to vary at least one of a range and a flowrate of the laminar airflow.

In some implementations of the method, the method can include increasing a flow resistance to the incoming second airflow in a lower part of the air chamber.

In some implementations of the method, the method includes expelling air from the air chamber via an air outlet. Optionally, the method can include preventing air from entering the air chamber via the air outlet.

In some implementations of the method, the method can include sealing the air chamber at an interface between the face and the air chamber.

In some implementations of the method, the method can include deflecting a third airflow upwardly for converting the third airflow into a secondary laminar airflow, thereby forming a secondary air shield that guides air expelled from the air chamber between the laminar airflow and secondary laminar airflow.

Various implementations, features, and aspects of the present assembly and related method are further described herein, including in the claims, figures, and following description.

### BRIEF DESCRIPTION OF THE DRAWINGS

The terms Fig., Figs., Figure, and Figures are used interchangeably in the specification to refer to the corresponding figures in the drawings.

Implementations of the facial mask assembly are represented in and will be further understood in connection with the FIGS. 1 to 25.

FIG. 1 is a side view of a two-hull embodiment of the facial mask assembly positioned to a face region of a user to cover naso-buccal passages.

FIG. 2 is a perspective rear side view of the two-hull embodiment of the facial mask assembly of FIG. 1.

FIG. 3 is a perspective cross-sectional front view of the two-hull embodiment of the facial mask assembly of FIG. 1.

FIG. 4 is a cross-sectional view of a side portion of the two-hull embodiment of the facial mask assembly of FIG. 1.

FIG. 5 is a cross-sectional view of another side portion of the two-hull embodiment of the facial mask assembly of FIG. 1.

FIG. 6 is a cross-sectional view of another side portion of the two-hull embodiment of the facial mask assembly of FIG. 1 showing a first air inlet.

FIG. 7 is an exploded view of components of the two-hull embodiment of the facial mask assembly of FIG. 1.

FIG. 8 is an exploded perspective upper view of components of the two-hull embodiment of the facial mask assembly of FIG. 1.

FIG. 9 is an exploded perspective side view of components of the two-hull embodiment of the facial mask assembly of FIG. 1.

FIG. 10 is an exploded cross-sectional view of components of the two-hull embodiment of the facial mask assembly of FIG. 1.

FIG. 11 is another exploded perspective side view of components of the two-hull embodiment of the facial mask assembly of FIG. 1.

FIG. 12 is a cross-sectional perspective view of a portion of the two-hull embodiment of the facial mask assembly of FIG. 1 showing a deflecting lip.

FIG. 13 is an exploded perspective view of a portion of the two-hull embodiment of the facial mask assembly of FIG. 1 showing a one-way valve and a plug connector.

FIG. 14 is a schematic representation of simulated airflows stemming from an external source (X3), from an outlet releasing expelled air (X4), from a deflecting path forming a laminar airflow (X2) and from a secondary deflecting path forming a secondary laminar air flow (X1).

FIG. 15 is a schematic representation of a cross-section of a two-hull embodiment of the facial mask assembly.

FIG. 16 is another schematic representation of a cross-section of a two-hull embodiment of the facial mask assembly.

FIG. 17 is a perspective side view of a two-hull embodiment of the facial mask assembly.

FIG. 18 is a perspective upper view of the two-hull embodiment of the facial mask assembly of FIG. 17

FIG. 19 is another schematic representation of a cross-section of a two-hull embodiment of the facial mask assembly including a deflection wall

FIG. 20 is a perspective semi-transparent front view of a single-hull embodiment of the facial mask assembly.

FIG. 21 is an exploded perspective side view of the single-hull embodiment of the facial mask assembly of FIG. 20.

FIG. 22 is a perspective front view of another single-hull embodiment of the facial mask assembly including fans encased in blowing chambers.

FIG. 23 includes a schematic of a perspective rear view of a mannequin wearing a single-hull embodiment of the facial mask assembly and a portable controller unit, a photograph of an example controller unit, and another photograph of the inside of the controller unit.

FIG. 24 is a photograph of an experimental setup treated via a Matlab software to reveal airflows surrounding a deactivated single-hull facial mask assembly.

FIG. 25 is a photograph of an experimental setup treated via a Matlab software to reveal airflows surrounding a single-hull facial mask assembly.

While the invention will be described in conjunction with example embodiments, it will be understood that it is not intended to limit the scope of the invention to these embodiments.

### DETAILED DESCRIPTION

The present techniques relate to the field of personal protective equipment, and more particularly to a facial mask assembly being designed to channel at least two separate bodies of air for distribution thereof to specific regions of the face of a user. The facial mask assembly is configured to supply a first body of air to naso-buccal passages of a face region for oxygenation of the user, and to direct a second body of air substantially along uncovered face regions.

The present facial mask assembly is configured to dispense the second body of air as a laminar airflow that acts as an air shield for uncovered face regions that would otherwise be exposed to contaminants of the ambient air. Uncovered face regions refer to regions of the face or surrounding the face of a user and that are not covered by components of the facial mask assembly. Uncovered face regions can include, at least in part, the cervical region, the buccal region, the infraorbital region, the parotid region, the zygomatic region, the temporal region, the auricular region, the ocular/orbital region, the frontal region and the hair line. The regions that are covered by the facial mask assembly are, at least in part, the oral region and the nasal region encompassing the naso-buccal passages.

Contaminants as referred to herein are contaminants that are contained in the ambient air and that can contaminate the human body via exposure of the face or face region to ambient air. These contaminants include chemical substances (inorganic volatile molecules including gases, organic volatile molecules or macromolecules, toxic or not), microbial particles (viruses, bacteria, fungi, parasites, and sporulated forms thereof), airborne particles (dust, particles, etc.), and airborne aggregates of such contaminants (fomites, aerosols, etc.). Contamination can occur via naso-buccal passages, ocular passages, and auricular passages when in contact with the contaminants present in ambient air. For example, contamination of eye surfaces by microbial particles such as viruses can lead to an infection which may, due to retrograde axonal transport, induce a nervous system disorder. It should be noted that the ocular region refers herein to the region encompassing both ocular/orbital passages of the user.

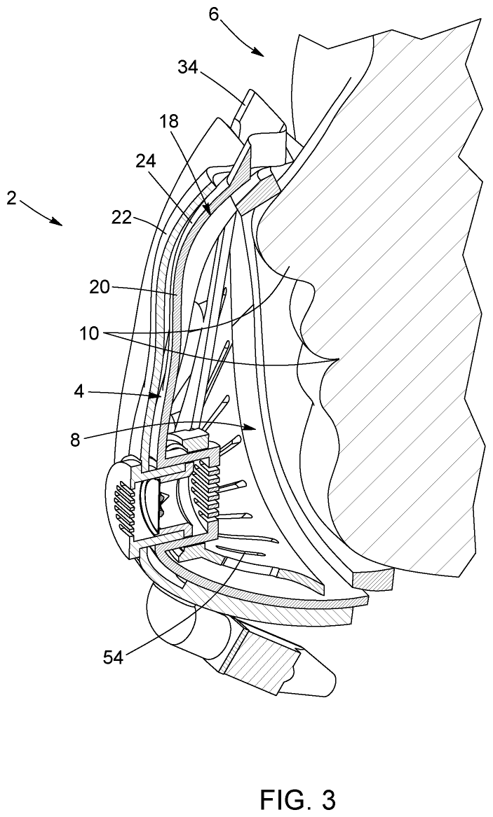

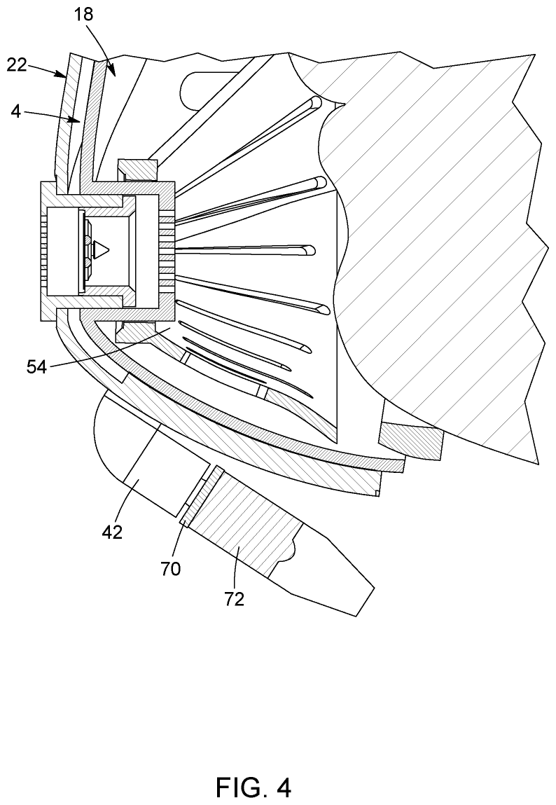

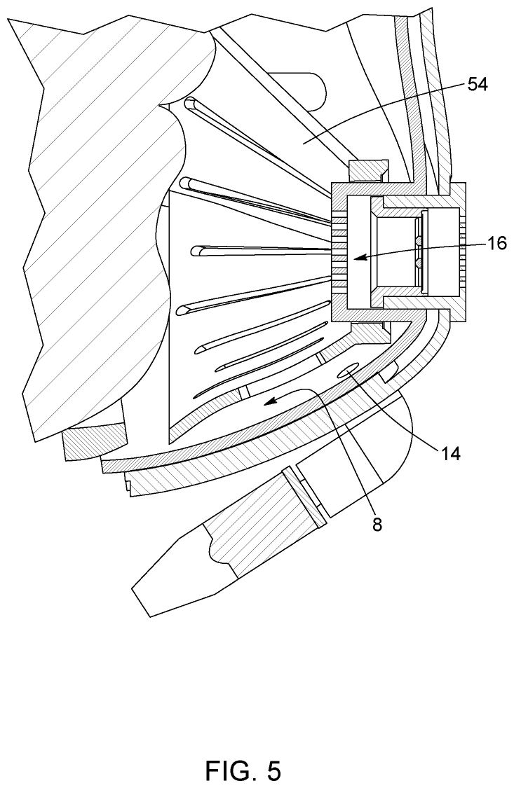

More particularly, referring to FIG. 3, the facial mask assembly (2) defines a deflecting air path (4) that can be fed with a first body of air for conversion thereof into a laminar airflow flowing along uncovered portions (6) of the face region to form an air shield. The facial mask assembly (2) further defines an air chamber (8) in fluid communication with the naso-buccal passages (10), and that can be fed with a second body of air. Referring to FIG. 4, the facial mask assembly (2) can further define a first air inlet channel (12) in fluid communication with the deflecting air path (4). Referring to FIG. 5, the facial mask assembly (2) can further define a second air inlet channel (14) in fluid communication with the air chamber (8). The facial mask assembly can further define air outlet channel (16) in fluid communication with the air chamber (8) so as to expel air from the air chamber (8) outside of the facial mask assembly.

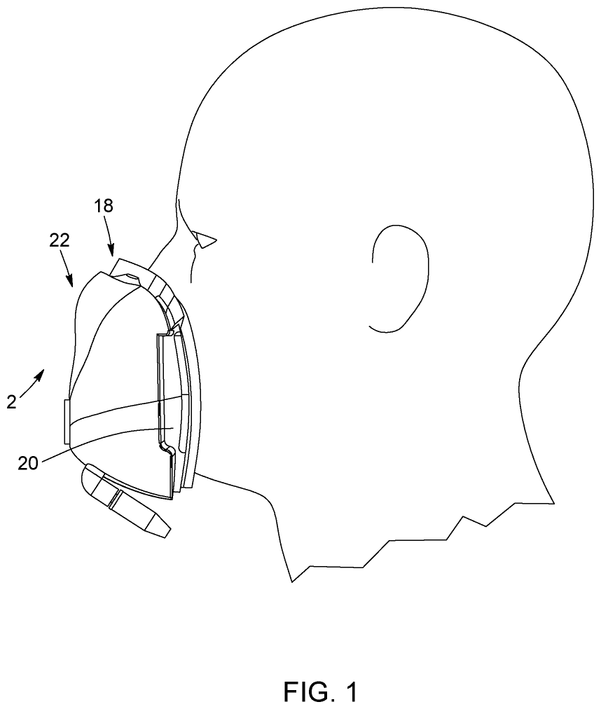

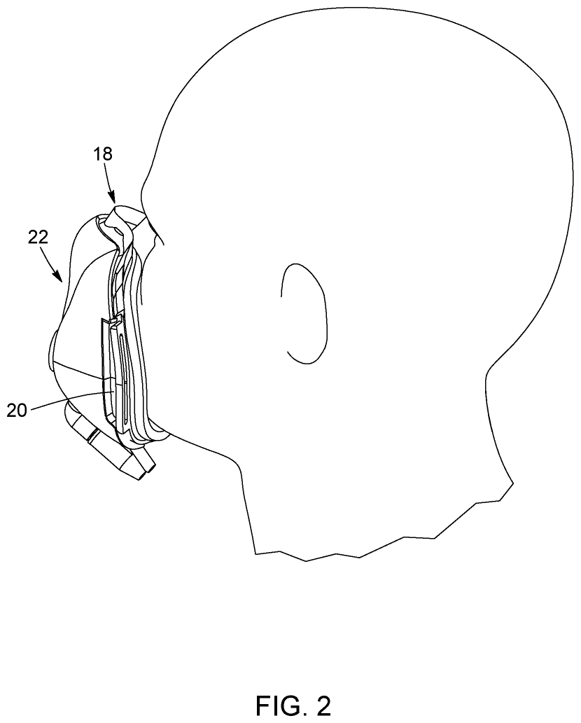

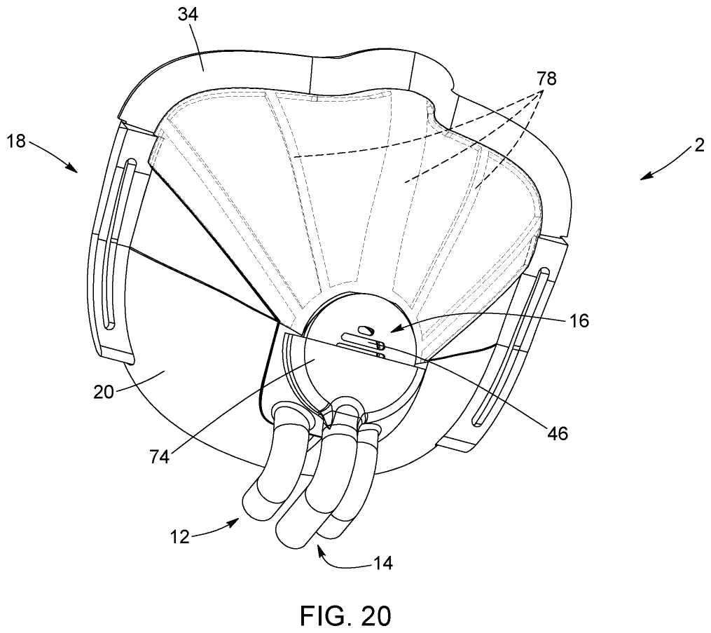

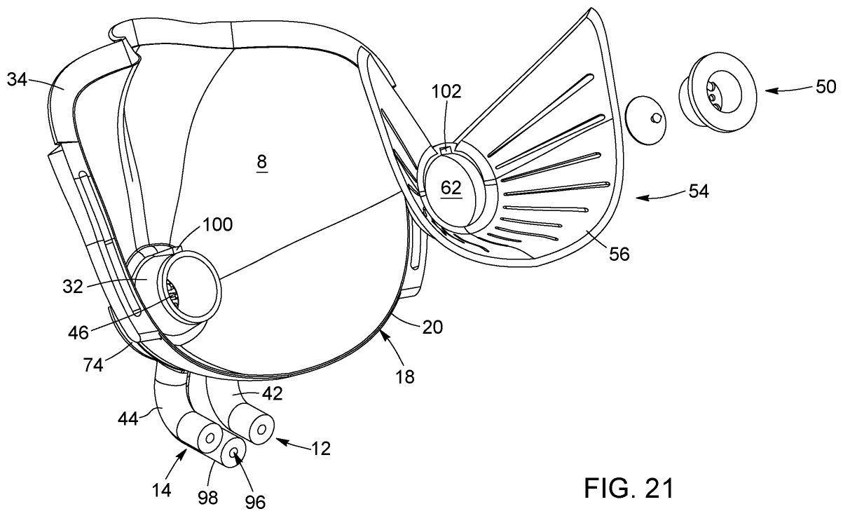

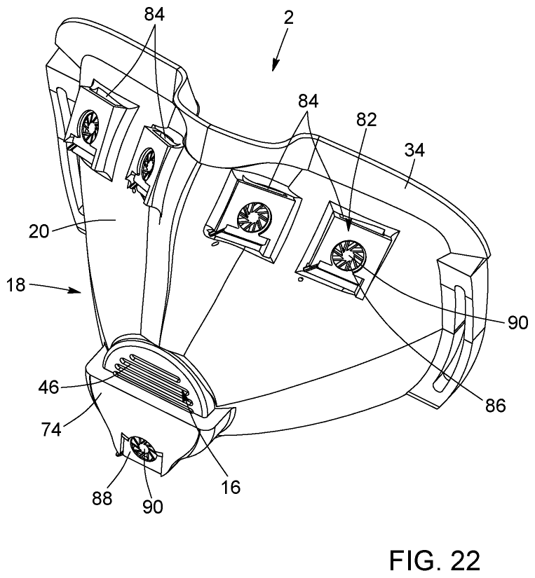

Multiple implementations of the facial mask assembly are described herein. A general description of the configuration of the mask is provided above with respect to FIGS. 3 and 5, but it should be understood that all implementations of the facial mask assembly illustrated in the Figures and encompassed in the description and claims are configured to include a deflecting air path that converts a first body of air into an air shield for uncovered regions of the face, and an air chamber to supply a second body of air to the naso-buccal passages of the face. The implementations of the facial mask assembly that are described herein provide for different configurations of the deflecting air path. For example, FIGS. 1 to 13 and 17 to 19 illustrate implementations of the facial mask assembly where the deflecting air path is defined in part by a gap between a main hull and an outer hull of the assembly, whereas FIGS. 20 and 21 illustrate an implementation of the facial mask assembly wherein the air deflecting path is defined in part by multiple air channels embedded within a main hull, and FIG. 22 illustrates an implementation of the facial mask assembly where the deflecting air path is defined in part by multiple blowing chambers distributed along a main hull.

One skilled in the art will thus readily understand that the design of the components of the facial mask assembly illustrated in the Figures can vary as long as the facial mask assembly defines at least one deflecting air path, an air chamber, at least two air inlets to respective deflecting air path and air chamber, and at least one air outlet from the air chamber.

### Air Chamber

Referring to FIG. 1, the facial mask assembly (2) includes a main hull (18) that is positionable with respect to the face region so as to cover naso-buccal passages and form the air chamber. The main hull (18) can include a main component (20) that is shaped like a cup. The cup-like shape of the main component (20) refers herein to a shape that is curved to form an arch allowing coverage of naso-buccal passages of someone's face and defining the air chamber in fluid communication with the naso-buccal passages. Curvature of the cup-like shape may vary along a surface of the main hull (18) so as to adapt to the face contours, and more particularly to accommodate the prominence of a nose region.

### Deflecting Air Path

The deflecting air path is creating the laminar airflow that can be defined as composed of a multitude of quasi parallel airflows travelling at similar speeds and generated by the interaction of the first body of air with the deflecting air path. The deflecting path can be formed in various ways. The deflecting path includes a deflecting lip (34) that extends from the main component (20) of the main hull (18), as seen for example in FIGS. 3, 20 and 22, along which the first body of air can flow and be upwardly circulated as a laminar airflow towards upper regions of the face (ocular region and frontal region). The deflecting air path can further be defined in part by a gap (24) between two hulls as seen in FIG. 3, multiple channels (78) within a main hull as seen in FIG. 20, or blowing chambers (82) distributed at a surface of a main hull as see in FIG. 22.

Gap Implementations

In some implementations, referring to FIG. 1, the facial mask assembly (2) can further include an outer hull (22) providing coverage to the main hull (18). Providing coverage can be interpreted herein as being sized and shaped to cover at least a portion of the main hull. For example, the outer hull can be sized and shaped to cover at least a portion of the main component. For example, as seen in FIG. 3, the outer hull (22) can be sized and shaped to cover substantially all of the main component (20) of the main hull (18) while leaving other portions exposed. FIGS. 1 to 13 illustrate an implementation of the face mask assembly where the outer hull is shaped similarly to the main component of the main hull. However, it should be noted that the outer hull could be shaped differently from the main hull without departing from the scope of the present techniques.

Referring to FIG. 3, the outer hull (22) is positioned with respect to the main hull (18) to define a gap (24) there between. The gap (24) can extend along at least a portion of the main hull (18) and can be fed with the first body of air, the latter further flowing along the gap and exiting the gap from an upper end region of the outer hull (22). One can see from the embodiments illustrated in FIGS. 1 to 13, 17 and 18 that some portions of the outer hull can be in contact with the main hull such that there is no gap in between.

The gap between the main hull and the outer hull is part of the deflecting air path that is responsible for the formation of the laminar airflow. More specifically, the gap can be supplied with the first body of air such that the first body of air flows upwardly along the gap toward the upper end region of the main hull. The geometry of the gap, including area and width, can be selected in accordance with a range and flowrate of the resulting laminar airflow. The width of the gap can be adjusted to vary a flowrate of the first body of air when the latter travels the deflecting path. The width of the gap between the outer hull and the main hull can range between 1 mm and 10 mm, or between 1 mm and 5 mm. Optionally, the width of the gap and the inlet flowrate of the air entering the deflecting air path can be adjusted to vary the generated laminar flowrate of the resulting laminar airflow. For example, the laminar flowrate can be of at least 0.1 L/min. If the outer hull is shaped similarly to the main hull, one can expect the width of the gap to be constant across the surface of the hulls. However, it should be noted that the width of the gap may differ from one hull region to another hull region, in accordance with the variation in the shape of the main hull with respect to the outer hull.

The laminar airflow that is created upon passage into the deflecting path allows forming an air shield which protects the uncovered face regions from exposure to, for example, aerosols, droplets, and fomites that can carry and transmit contaminants. In addition, the laminar airflow can assist the user in reducing and eliminating any fog that can accumulate around the ocular region, especially when the user is further wearing googles or a face mask.

Though not illustrated in the Figures, the outer hull can be directly connected to the main hull via engagement of a portion of the outer hull with another portion of the main hull while leaving the gap between a remaining portion of the main hull and outer hull. Alternatively, the facial mask assembly can include a connector or connection mechanism that is configured to hold the main hull and the outer hull together while allowing the gap to be defined there between. Various ways can be used to configure the connection mechanism for that purpose.

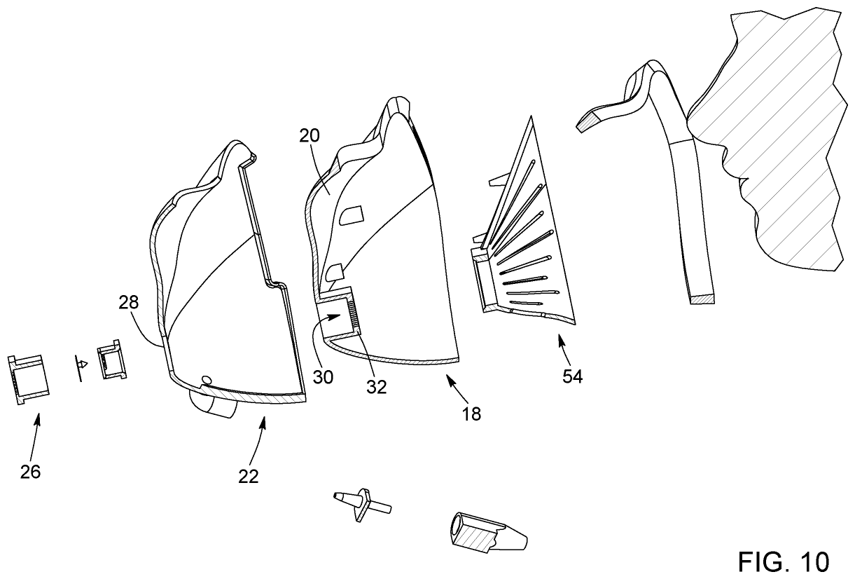

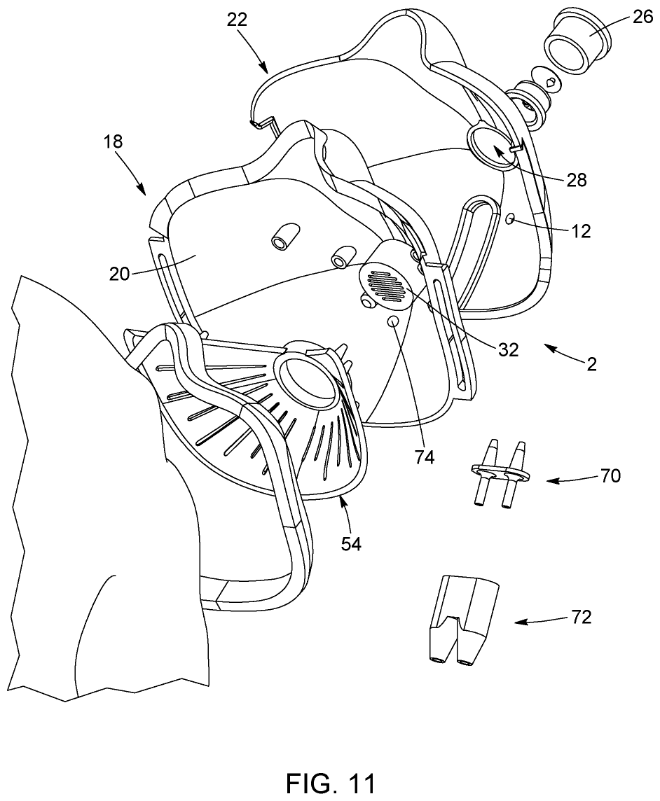

In the implementation illustrated in FIGS. 10 and 11, for example, the connection mechanism can include a plug connector (26) that is sized and shaped to be inserted in an aperture (28) defined in the outer hull and further engaged in a cavity (30) defined by the main hull (18). More specifically, the cavity (30) can be defined by a protrusion (32) that extends inwardly from a central portion of the main component (20) in the air chamber towards the naso-buccal passages, the cavity (30) having at least an opening from the gap side so as to receive the plug connector (26) therein. The plug connector (26) can be engaged to the outer hull (18) and be secured to the main hull (18) in various ways. For example, the plug connector (26) can be screwed in the main hull (18) or inserted directly in the main hull (18). A sealing member could be added to avoid any leakage.

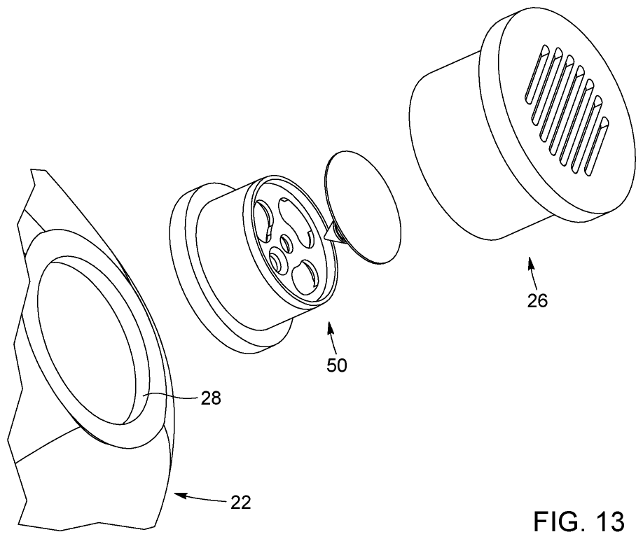

It should be noted that the implementations of the face mask assembly illustrated in the Figures are designed to combine the air outlet channel (16), the plug connector (26) and an air valve (50). For example, as better seen on FIG. 13, the air valve (50) and plug connector (26) cooperate together to define two complementary pieces and a thin diaphragm across the outlet channel (16). The two pieces can be assembled by friction and the diaphragm is positioned between the two pieces via insertion of a conic protrusion extending from the diaphragm into a hole of the proximal piece. However, the design of the face mask assembly can vary, and, for example, the connection mechanism holding the main hull and the outer hull can be designed separately from the outlet channel without departing from the scope of the present assembly. In another example, the outer hull itself can include a protrusion that can be inserted into the main hull for connection thereto.

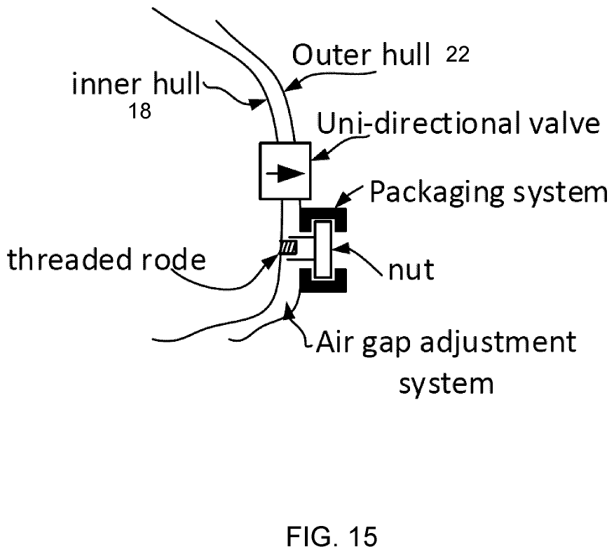

The facial mask assembly can further include an adjustment mechanism allowing adjusting at least the width of the gap. For example, the adjustment mechanism can include an adjustment screw that is engaged with the connector as described above. In another example, a threaded mini hole can be designed on the main hull, then a screw fixed on the outer hull and inserted in the threaded hole adjusts the width of the gap. In yet another example, referring to FIG. 15, a threaded bolt (rod) and nut assembly can be used to adjust the width of the gap between the main hull and the outer hull.

Multiple Channels Implementations

In other implementations, the deflecting path can include multiple channels that are embedded and distributed within the main hull as a network. For example, referring to FIG. 20, the network of channels (78) can be formed within the main hull (18) with each channel (78) being supplied with a portion of the first body of air that is flowing from the air inlet channel (12). The first body of air can then be distributed around the face from an outlet of each channel to create the laminar airflow serving as a face shield. For example, the channels (78) can be integral with the main component (20) of the main hull (18) as a one-piece structure. In another example, the channels (78) can be sandwiched between two layers of the main hull.

In some implementations, the channels can be defined as micro-channels having a cross-section that can be of various shapes. For example, the cross-section of the channels can be circular. For example, the cross-section of the channels can be rectangular. For example, the cross-section of certain channels can vary in shape from the cross-section of other channels. Optionally, an average diameter of each channel can be between 0.1 mm and 10 mm, for example between 2 mm and 5 mm. Further optionally, the channels can have a rectangular cross-section having a width between 0.1 mm and 2 mm, and a length between 1 mm and 5 mm. The outlets of the channels can be equally distributed along a circumference of the main hull or concentrated in specific area of the main hull depending on the shape of the desired face shield protection.

The use of multiple channels embedded in the main hull can present some advantages with respect to the use of a gap between an outer hull and a main hull. For example, the distribution of the first body of air via the network of channels can facilitate the achievement of an adequate laminar airflow when a feed pressure of the first body of air is of lower value. In addition, the presence of the embedded multiple air channels in the main hull (compared to a gap) allows for the removal of the outer hull, thereby contributing to a lighter, simpler and cheaper facial mask assembly.

Blowing Chambers Implementations

In some implementations, the first body of air can be provided via multiple blowing chambers having an outlet proximal to the base of the deflecting lip. More particularly, referring to the facial mask assembly illustrated in FIG. 22, the first body of air can be provided through several primary blowing chambers (82) distributed across a surface of the main hull (18) and substantially aligned with a curve of the deflecting lip (34). The first body of air is provided from an outlet (84) of each primary blowing chamber (82), with the outlet (84) being oriented to provide the first body of air proximal to the base of the deflecting lip for further formation of the laminar airflow.

The outlet (84) of each primary blowing chamber (82) can have the same geometry, or each outlet can have a geometry tailored to its position over the surface of the main hull and with respect to the deflecting lip (34). For example, each outlet can have a rectangular cross-section having a width between 1 mm and 3 mm, and a length between 5 mm and 15 mm. The dimensions of the outlet can vary from what is illustrated in the Figures and can be chosen to maximize the amount of air that is blown from the fan to the deflecting lip while maintaining a given flowrate.

Deflecting Lip

Referring to FIGS. 3, 20 and 22, the deflecting air path is further defined by a deflecting lip (34) that is part of the main hull (18) and extends outwardly from an end portion of the main component (20). The deflecting lip (34) is tapered at a given angle to deflect the travelling first body of air according to this given angle, thereby creating the laminar airflow flowing outwardly along the exposed face regions. It should be noted that laminar refers herein to the condition of the airflow that spreads away from the mask assembly (2) in a same orientation defined by the angle of the deflecting lip (34).

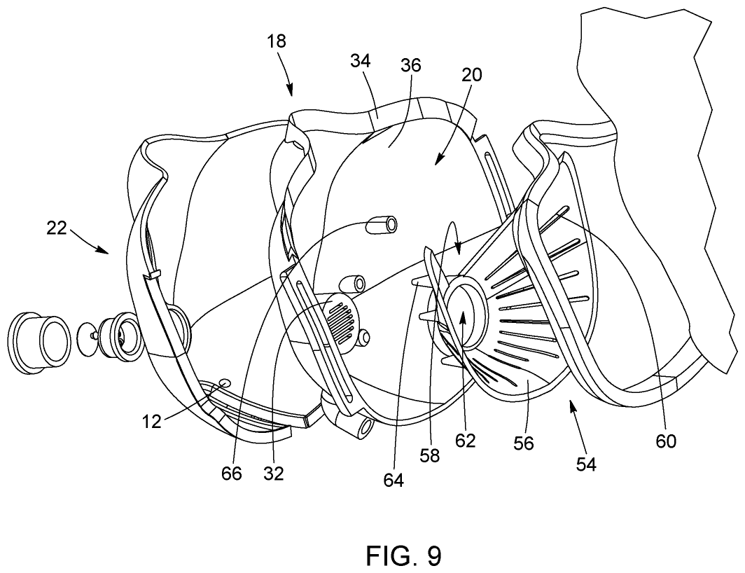

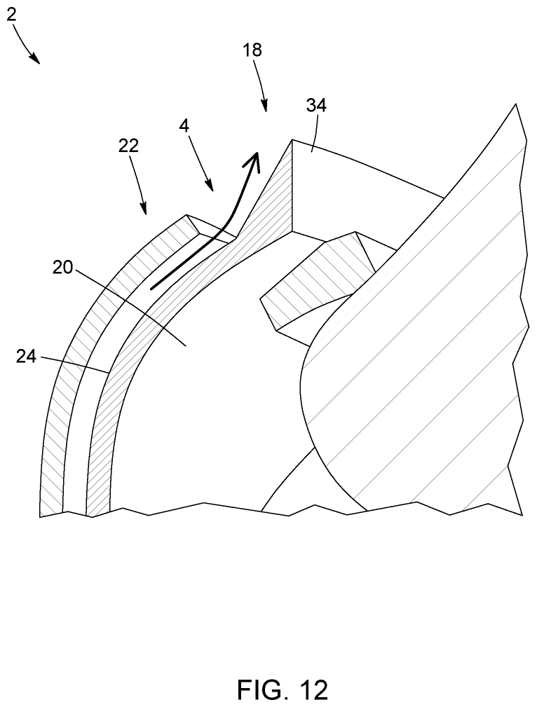

Referring to the implementation illustrated in FIG. 12, in addition to the gap (24), the deflecting air path (4) is further defined by the deflecting lip (34) to deflect the first body of air that exits the gap (24) between the main hull (18) and the outer hull (22) to generate the laminar airflow flowing outwardly along the exposed face regions. Referring to the implementation illustrated in FIG. 20, the deflecting air path is defined by the combination of the multiple channels (78) and the deflecting lip (34), such that the first body of air can exit from an outlet of the multiple air channels (78) to flow along the deflecting lip (34) for further generation of the air shield/laminar airflow. Referring to the implementation illustrated in FIG. 22, the deflecting air path is defined by the combination of each blowing chamber (82) and the deflecting lip (34), such that the first body of air can exit from an outlet (84) of each blowing chamber (82) that is oriented towards the deflecting lip (34) for further generation of the laminar airflow. As better seen in the example of FIG. 9, the end region of the main component (20) can include an upper end region (36) such that the deflecting lip (34) extending from the upper end region (36) produces a laminar airflow that is able to protect an ocular region of the user's face. The ocular region, also referred to as the orbital region, is located in an upper region of the user's face, and includes as used herein both orbital passages and eyes. Although not illustrated in the Figures, the end region that is encompassed herein can further include a side end region of the main component such that the resulting laminar airflow is able to protect the auricular region. The end region that is encompassed herein can further include a lower end region of the main component such that the resulting laminar airflow is able to protect the cervical region. One skilled in the art will readily understand that the size and angle of the deflecting lip can thus be adapted to protect at least the ocular region, and further optionally at least one of the auricular region and the cervical region. FIGS. 1 to 3, 7 to 12, and 17, 18 and 20 to 22 show implementations where the deflecting lip (34) extends from the upper end region (36) of the main component (20) so as to form an air shield to at least the ocular region, and optionally further to the frontal region.

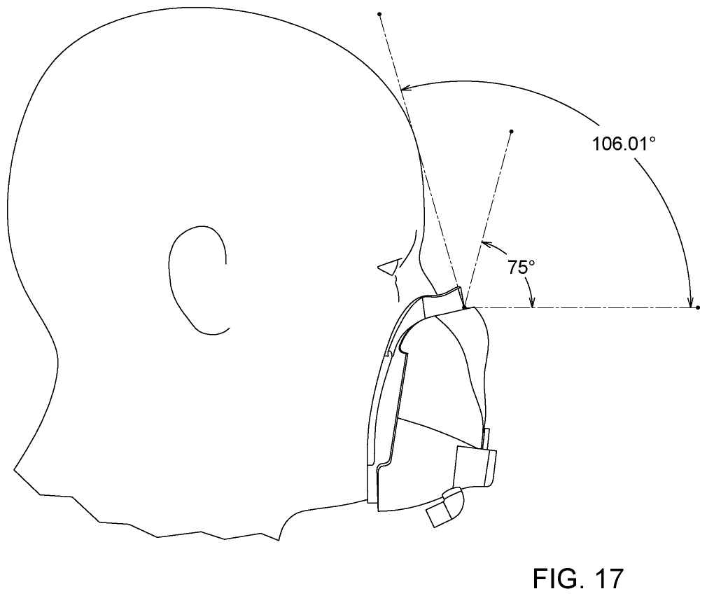

The deflecting lip can be further defined by multiple lip portions, each lip portion being tapered at an angle differing from another lip portion depending on the face region to be protected by the corresponding generated laminar airflow. For example, when the deflecting extends to generate a laminar airflow over the ocular region, referring to FIG. 17, the deflecting lip is tapered at an angle ranging from about 75 and about 120 degrees, optionally between about 75 and about 106 degrees. Although not illustrated in the Figures, the deflecting lip can further extend on side edges of the main hull and can include a side lip portion being tapered at an angle between about 135 and about 155 degrees to generate a laminar airflow over the auricular region. The deflecting lip can further extend on a lower edge of the main hull and can include a lower lip portion being tapered at an angle between about 90 and about 130 degrees to generate a laminar airflow over the cervical region. It should be noted that the angles are provided as an indication and can vary depending on morphological parameters of the exposed face regions to be protected. In some implementations, the angle of the deflecting lip can be selected to produce a laminar airflow that flows along an exposed face region and at a given distance from this face region. The angle can be chosen to generate a laminar airflow able to compensate drag forces due to motion of the user. The distance between the face region and the laminar airflow can be increased to compensate for body motions of larger amplitude.

The material of each one of the main hull, and the optional outer hull, can be selected according to a desired flexibility and transparency. For example, if the hull is to be rigid, the hull can be made of resin or plastic such as (high-impact) polystyrene, acrylonitrile butadiene styrene (ABS), polypropylene, low-density polyethylene (LDPE), polyurethane, epoxy, unsaturated polyester, acrylic, silicone rubber, polycarbonate, polyoxymethylene (POM), cyclic olefins, etc.), or of hybrid/composite materials. The rigidity of the material(s) used to fabricate the hull(s) can facilitate the control of the flowrate of the first body of air travelling along the deflecting path to form the laminar airflow. In another example, if the hull is to have some flexibility, the hull can be made of a flexible resin or plastic such as low-density polyethylene (LDPE), polyurethane, epoxy, silicone rubber, 80A/50A resin, etc.), or of hybrid materials. Optionally, one or both hull(s) can be made of paper, resin-reinforced paper, or cardboard. Further optionally, one or both hull(s) can be made of a composite material including a combination of at least two of resin, plastic, paper, and cardboard.

### Flow Control Component

To further contribute to the comfort and efficiency of the facial mask assembly, a flow control component (54), as exemplified in FIGS. 3 to 11, can be operatively connected to the main hull and located within the air chamber with the aim of creating a local flow resistance to the incoming second body of air in a lower region of the air chamber.

Referring to FIG. 9, the flow control component (54) can be opened in at least a portion thereof, to optimize a flow of the second body of air toward the nasal passages. For that purpose, the flow control component (54) can include a frustro-conically shaped member (56) having a primary opening (58) in an upper part thereof and that is sized to accommodate the nasal region. A V-shaped opening is illustrated in the Figures, but a geometry of the opening could vary and include, for example, curved edges. The flow control component (54) further includes multiple secondary openings (60) that are smaller in size so as to increase the flow resistance in the lower region of the chamber. The provided hydrodynamic resistance is thus higher in the surroundings of the air inlet and can decrease towards edges of the flow control component, the borders, so as to force the airflow circulation towards areas of low resistance. Optionally, the secondary openings (60) can be shaped as slots, each slot becoming wider the further they are from the air inlet. The secondary openings could alternatively be shaped as holes of varying diameter depending on their position with respect to the air inlet. Such feature is used mainly for the comfort of the user so that he is not exposed to an exceedingly high air pressure at the air chamber inlet.

Still referring to FIG. 9, the flow control component (54) can be secured to the main hull (18) via insertion of the proximal end of the protrusion (32) into a dedicated aperture (62) of the frustro-conically shaped member (56). This design facilitates centering of the flow control component with respect to the air chamber. Additional components can be provided to further facilitate the positioning and securing of the flow control component. For example, the flow control component (54) can include a plurality of elongated projections (64) extending from the frustro-conically shaped member (56) towards the main hull (18) so as to serve as spacers between the main hull (18) and the flow control component (54), and to allow incoming air to be guided toward the main opening (58). The main hull (18) can further be provided with a plurality of tubular protrusions (66) extending from the main component (20) and towards the flow control component (54) so as to engage the elongated projections (64). In another example, referring to FIG. 20, the securing mechanism can include a lip (100) protruding upwardly from the protrusion (32) and a notch (102) defined in the aperture (62) of the frustro-conically shaped member (56). The notch (102) is complementary in shape to the lip (100) to as to secure the flow control component (54) to the main hull (18) and avoid respective rotation thereof.

### Air Inlet Implementations

The first and second bodies of air can be supplied to the deflecting air path and air chamber respectively in multiple ways.

For example, the first body of air can be supplied to the deflecting air path via a first air inlet, and the second body of air can be supplied to the air chamber of the assembly by a second air inlet. Both first and second air inlets are said to be part of an inlet unit of the facial mask assembly. FIGS. 1 to 13 illustrate an embodiment of the facial mask assembly including the first air inlet (12) being defined in the outer hull (22) and the second air inlet (14) being defined in the main hull (18). FIGS. 20 and 21 illustrate another embodiment of the facial mask assembly (2) including the first and second air inlets (12, 14) being both defined in the main hull (18) to supply respectively the first body of air to the multiple channels (78) and the second body of air to the air chamber. FIG. 22 illustrates an implementation of the facial mask assembly (2) including multiple primary air inlets (86) defined by an aperture in each primary blowing chamber (82) defined in the main hull (18) to supply the first body of air to deflecting lip (34), and by a secondary air inlet (88) defined in a lower region of the main hull (18) to supply the second body of air into the air chamber.

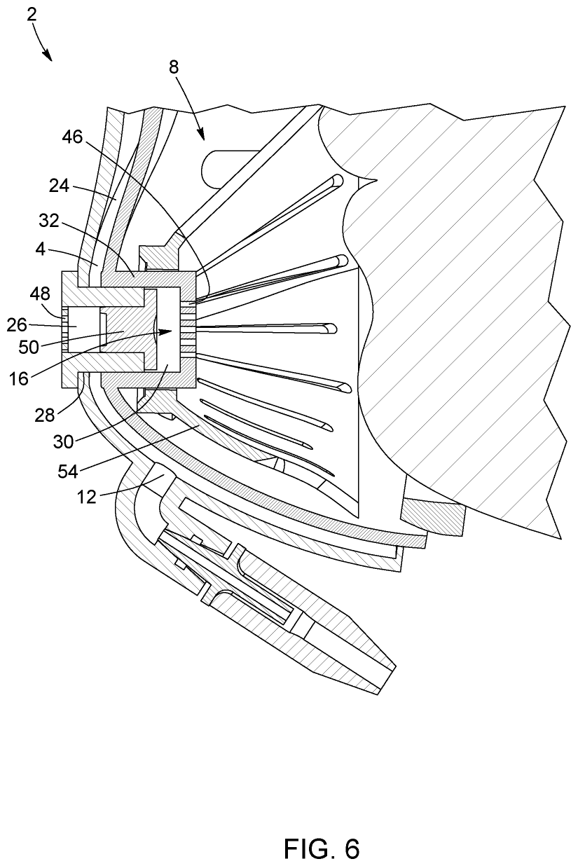

More specifically, referring to FIG. 6, the inlet unit comprises a first inlet (12) in fluid communication with the deflecting path (4) between the main hull (18) and the outer hull (22) to provide the first body of air therein at a first flowrate. Referring to FIG. 5, the inlet unit further includes a second air inlet (14) in fluid communication with the air chamber (8) formed by the main hull (18) to provide the second body of air therein at a second flowrate. As can be seen in FIG. 11, the first air inlet (12) can be defined at a proximal end thereof by an aperture in a lower region of the outer hull (22), and the second air inlet (14) can be defined at a proximal end thereof by a second aperture defined in a lower region of the main hull (18). The geometry of the apertures forming the air inlets (12, 14) can be varied in accordance with the inlet flowrates that are to be achieved.

Referring to the implementation illustrated in FIGS. 20 and 21, both the first air inlet (12) and the second air inlet (14) can be defined in the main hull (18) to provide, respectively and independently, the first body of air to the multiple air channels (78) (seen in FIG. 20), and the second body of air to the air chamber (8) defined by the main hull (18) (seen in FIG. 21).

Referring to the implementation of FIG. 22, each one of the primary air inlets (86) can be sized to encase a fan (90) that is actuable to let a portion of the first body of air flow into the corresponding blowing chamber (84) and out of said chamber (84) via the corresponding outlet (86) at the first flowrate. The secondary air inlet (88) is also sized to encase another fan (90) that is actuable to let the second body of air flow into the air chamber at the second flowrate.

It should be noted that the second body of air can be provided at the second flowrate into the air chamber so as to maintain a positive pressure within the air chamber. For example, the pressure inside the air chamber can vary to ensure comfort of the user while ensuring a positive pressure inside the air chamber. Optionally, the pressure inside the air chamber can be between 0.01 psi and 0.02 psi.

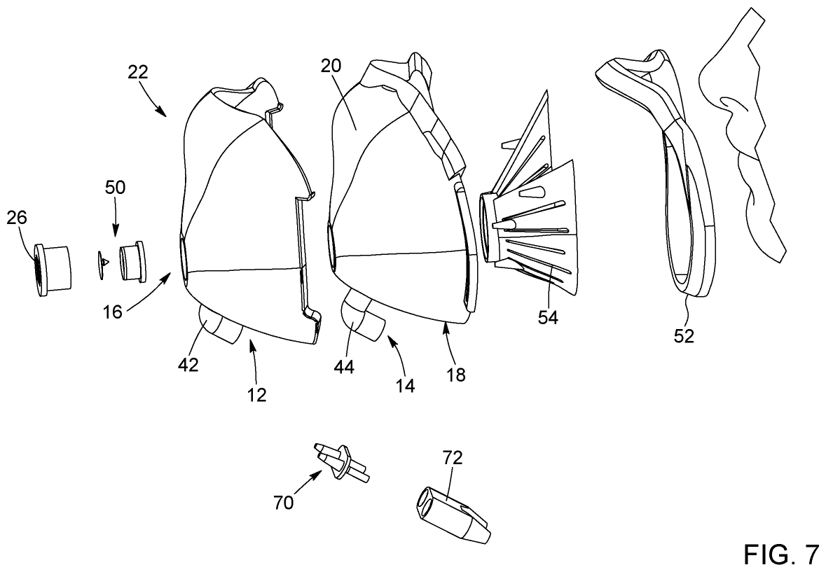

In some implementations, the inlet unit can include hollow components that are operatively connected to the above-defined inlets so as to ensure fluid communication of the corresponding channels with the air chamber or deflecting path. The inlet unit can for example include one or more components allowing connection of the first and second air inlets to an air source, including for example connectors (42, 44, 70) and a holder (72). The inlet unit can include a first tubular connector (42) that is connected to the first air inlet (12) in the outer hull (22) as seen in FIG. 7 or in the main hull (18) as seen in FIG. 21, that is supplied with the first body of air. The inlet unit can further include a second tubular connector (44) that is connected to the second air inlet (14) of the main hull (18) as seen in FIGS. 7 and 21, and that is supplied with the second body of air. Referring to FIG. 11, the inlet unit can further include a connector (70) that can ensure a connection between one or more tubing lines (not shown) and the air inlets, and a holder (72) that is used to avoid any air leakage and facilitate handling of the tubing line(s).

In some implementations, the connection of the inlet unit to the incoming airflow(s) providing each body of air can be performed via one or more tubing lines. For example, referring to FIG. 7, the first tubular connector (42) and the second tubular connector (44) can each receive an incoming airflow via separate first and second tubing lines (not shown) that are connectable to a same air source or two different air sources (not shown). In another example, the first tubular connector and the second tubular connector can be supplied with a same incoming air flow via a main tubing line connectable to an air source.

In another implementation of the facial mask assembly illustrated in FIG. 22, the incoming airflow providing the first body of air at the first flowrate is generated by the fans (90) encased in the air inlets (86) to the deflecting path. In the fan-implementation, an additional connection to an air source via additional tubing is not required. Each fan (90) is actuable and controllable to generate the necessary flowrate. In this embodiment, it should be noted that the apertures (46) in the main hull also serve as the second air inlet and the apertures are optionally equipped with a filtering membrane to remove contaminants from the ambient air before the air is supplied to the air chamber and further supplied to the naso-buccal passages.

Optionally, a third body of air can be supplied to a secondary deflecting path via another dedicated air inlet. Details are further provided below.

### Air Outlet Implementations

Air from the air chamber can be expelled from the facial mask assembly via at least one air outlet defined by an outlet unit of the facial mask assembly.

Referring to FIG. 6, the outlet unit includes an air outlet (16) that is defined by a plurality of inner apertures (46) located at a proximal end of the protrusion (32) of the main hull (18), to ensure fluid communication between the air chamber (8) and the cavity (30) of the protrusion (32). The outlet unit further includes an outer air outlet (28) defined by an aperture in the outer hull (22). As seen in the implementation of FIG. 6 where a plug connector (26) is inserted in the outer air outlet (28) and further cavity (30), additional apertures (48) can be provided at a distal end of the plug connector (26) to allow air from the air chamber (8) to be expelled from the facial mask assembly (2) via the air outlet (16).

Referring to FIGS. 6 and 7, the outlet unit can further include a one-way valve (50) that can be inserted thought the air outlet (16) and outer air outlet (28) to be encased within the cavity (30) and to allow air from the air chamber to be expelled towards the outside of the mask assembly, while preventing air from entering the air chamber via the same path.

It should be noted that the design of the facial mask assembly illustrated in FIGS. 1 to 13 allows combining the outlet unit and connection mechanism for securing the outer hull to the main hull. However, one skilled in the art will readily understand that the outlet unit could be provided/located separately from the connection mechanism without departing from the scope of the present invention. For example, the facial mask assembly can be used in combination with an artificial breathing machine where the outlet unit can be operatively connected to the breathing machine.

Referring to the single hull implementations illustrated in FIGS. 20 and 22, the outlet unit can include the air outlet (16) that is defined by multiple apertures (46) in a lower central region of the main hull (18), such that air can be expelled from the air chamber via the apertures (46).

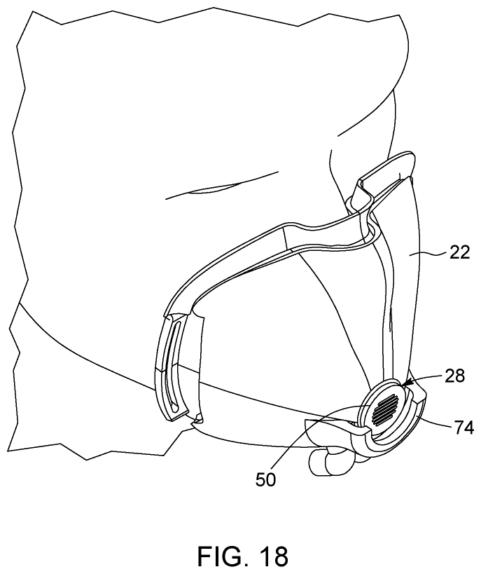

In some implementations, the outlet unit can further include at least one component defining a secondary deflecting air path to produce another laminar airflow acting as an air shield to prevent expelled air to be horizontally spread away from the mask assembly. For example, referring to FIG. 18, the facial mask assembly can include a deflection wall (74) that extends outwardly and upwardly from the outer hull (22) so as to divert the air that is expelled via the air outlet (28) through the apertures of the plug connector (50). The deflection wall (74) is designed to surround and extend upwardly ahead of at least a portion of the air outlet (28). The deflection wall (74) participates in creating the secondary deflecting air path to change a direction of the expelled air towards the upper part of the face, thereby avoiding spreading contaminated air in front of the user.

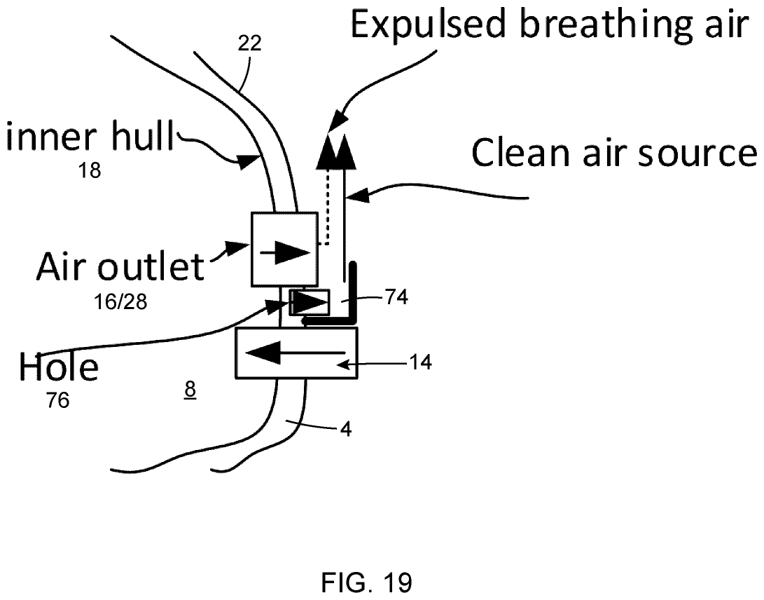

Optionally, referring to FIG. 19, a hole (76) can be defined in the outer hull (22) so as to be in fluid communication with the deflecting air path (4) receiving the first body of air. A portion of the first body of air can flow through the hole (76) and can thereby be deflected to create another laminar airflow that is able to prevent expelled breathing air to contaminate the front region of the face mask assembly. In another example, a separate and third body of air (different from the first body of air) can be circulated to create the laminar airflow along the secondary deflecting air path. Referring to FIG. 21, the inlet unit can include a third air inlet (96) and related tubular connector (98) providing the third body of air to the secondary deflecting air path defined by the deflection wall (74).

It should be noted that outlet unit or inlet unit as encompassed herein can be said to include apertures defined in specific components of the assembly, said apertures being involved in delimiting an air path or channel of the outlet or inlet unit. Additional tubing, or hollow component can be provided in connection to those already described to further define the deflecting air path, inlet channels and outlet channel according to a desired geometry. For example, the air outlet can be alternatively defined by apertures provided in a sealing member positioned between the face skin and the main hull.

It should further be noted that all parts and components that are described herein can be interconnected in a way that allows air to enter and exit the mask via the air inlets and outlets defined by the inlet unit and outlet unit encompassed herein. A fitting connection or additional sealing components can be used to ensure that air does not enter or escape the air chamber or deflecting path via another location than the designed air inlets or air outlets. For example, referring to FIG. 6, the plug connector (26) is fitted within the aperture of the air outlet (28) of the outer hull and further in the cavity (30) of the main hull so as to prevent air from the air outlet channel (16) to escape into the gap (24) along an exterior surface of the plug connector. Alternatively, all parts and components as described herein can be molded and integrated as a one-piece structure.

### Air Flowrate and Air Sources

It should be noted that the air inlets can be supplied with a same incoming airflow which provides for the two bodies of air, or each of the air inlet can be supplied with a separate incoming airflow providing for one body of air. One advantage of having separate incoming airflows providing for the bodies of air is to facilitate the independent control of the flowrate of each body of air entering the air chamber, the deflecting path, and the optional secondary deflecting path.

In some implementations, the air inlets can be independently connectable to a same air source, to provide the first body of air at a first inlet flowrate, the second body of air at a second inlet flowrate, and the optional third body of air at a third inlet flowrate. Optionally, the air chamber can be provided with air at the second inlet flowrate being lower than the first inlet flowrate of the first body of air being provided to the gap (and further forming the laminar airflow), to provide an enhanced comfort to a user of the facial mask assembly. For example, the first inlet flowrate can be of at least 0.1 L/min, and the second inlet flowrate can be higher or the same.

When separate incoming airflows are supplied to the inlet unit, they can optionally be sourced from the same air source or different air sources.

For example, the air source can be a portable generator that is held or attached to a user and generating the necessary airflow. The air source can alternatively be a generator located remotely from the user and accessible via connection of the air inlet unit of the mask assembly to an air source connector, such as an infrastructure ventilation system provided at a given location. For example, the air source connector can be provided in a hospital room, enabling a patient to connect his/her facial mask assembly to the air source connector to benefit from a corresponding incoming purified airflow.

The air source can generate purified air or purified similar (medical or industrial) gas formulation of oxygen (O₂) and nitrogen (N₂) via filtration, high-efficiency filtration (HEPA), and/or disinfection by ultraviolet (UV) radiation, thermal (>60° C.) disinfection, chemical disinfection, or any other methods known by those skilled in the art.

Alternatively, other techniques can be used to purify at least the second body of air entering the air chamber of the facial mask assembly. For example, the inlet unit can further include a filtering membrane positioned along the second inlet channel to remove contaminants from the second body of air flowing there through. A filtering body housing an N95, N99, or electrostatic filter membrane can be placed before the one or more air inlets to prevent the inhalation of microbial particles, aerosols, and or fomites.

### Additional Components

Sealing Member

Referring to FIG. 7, the air chamber that is defined by the main hull (18) when covering the naso-buccal passages can be further sealed via the use of a sealing member (52) that is secured to a circumference of the main hull (18).

When the main hull covers the naso-buccal passages, the sealing member comes into contact with the skin of the user to ensure proper sealing of the resulting air chamber. One skilled in the art can readily understand that a material of the sealing member is a flexible material that is compatible for contact with the skin. For example, the sealing member can be made of medical-grade silicon, a polymeric material, or biocompatible foam. Various ways can be used to secure the sealing member to the edge of the main hull including gluing, tape, or pressure.

Anchor Member

The facial mask assembly can be adapted to be secured to the head region from multiple locations of the assembly.

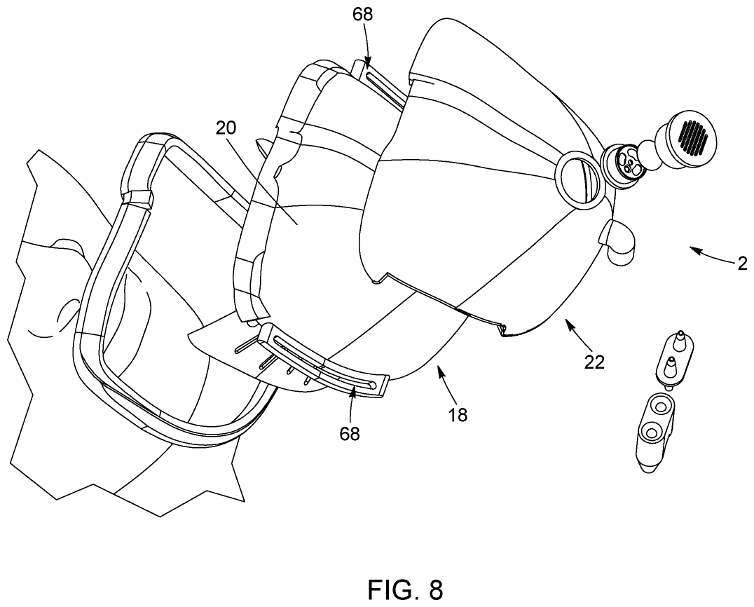

For example, as seen in FIG. 8, the main hull (18) of the facial mask assembly (2) can include two opposite anchor members (68) that extend from each side of the main component (20). Each anchor member (68) can be configured according to the type of connection required for anchorage to a strap component. Optionally, as seen in FIG. 9, each anchor member (68) can define a loop for insertion of the strap component therethrough (not illustrated). Anchors can be placed on the outer hull or form part of the outer hull. Anchors can be elastic wires or ribbons, made of fabric dressing, plastic or rubber, known by those skilled in the art.

### Monitoring and Control Implementations

In some implementations, the facial mask assembly can further include various measurement devices allowing to be informed in real time of at least one parameter including the first inlet flowrate, the second inlet flowrate, the laminar flowrate, a carbon dioxide level in the air chamber (CO₂ sensor), temperature (temperature sensor), humidity (humidity sensor), oxygen (oximeter), pH (pH sensor), breathing flowrate (flowmeter), etc. All these sensors can be integrated with the main hull, to monitor the inside of the air chamber, and/or integrated in a device that is mounted about the outlet channel, to monitor expelled air.

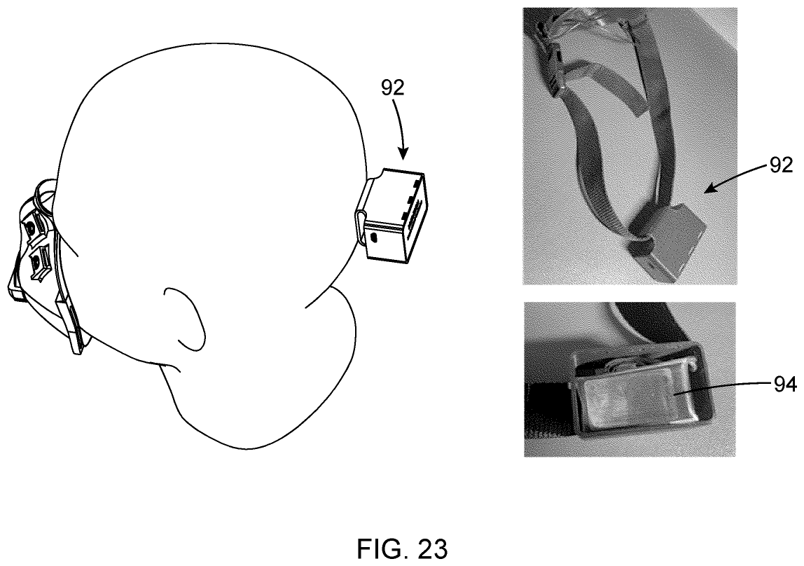

In some implementations, the facial mask assembly can include a control unit to adjust the flowrate of the incoming airflow. The control unit can be a portable remote control unit (92) as seen in FIG. 23, or integrated/encased in the main hull (not shown). The control unit can be used to adjust the first inlet flowrate and the second inlet flowrate independently. For example, to that effect, the control unit can include a first valve and a second valve to adjust the first and second flowrates that are supplied to air inlets of the assembly. The valves can be adjusted manually or automatically. If the adjustment is performed manually, the manual valve can be actuated by the user himself. If the adjustment is performed automatically, an automated system including an electronic valve with a feedback loop can be used. In another example, referring to FIG. 23, the control unit (92) can include a battery (93) that is operatively connected to the fans (90, in FIG. 22) for actuation thereof at a controllable speed generating the necessary flowrates for the resulting first and second body of air.

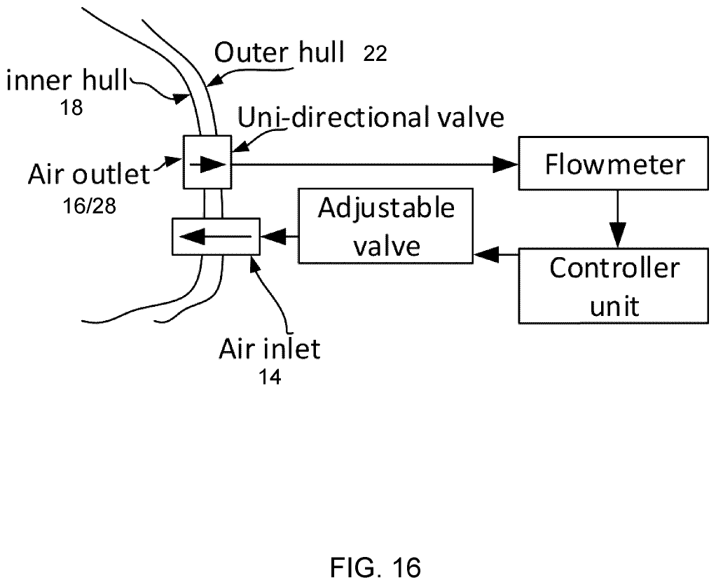

FIG. 16 illustrates an example closed loop system that is made of a flowmeter, a microcontroller, and an adjustable valve. The flowmeter can monitor the flowrate of the expelled air and provide this data to the microcontroller that can actuate the adjustable valve in order to regulate the flowrate of the second body of air that is provided to the air chamber. A similar loop could be used to monitor the flowrate of the laminar airflow and regulate the flowrate of the first body of air that is provided to the air deflecting path.

The quality of the air forming the first and second body of air can further be monitored and adjusted in multiple ways. As already mentioned, the air inlet unit can include a filtering membrane that is selected to remove one or more contaminant(s) from at least one of the first body of air and the second body of air. Alternatively, the facial mask assembly can be filterless when connected to an air source generating purified air. The air generated by the air source can thus be purified air to remove at least 90%, at least 95%, at least 99%, or at least 99.9% of the contaminants, or to provide the mask user with oxygen. The air quality of the two bodies of air can be different. For example, the first body of air being converted into the laminar airflow may contain non-contaminated particles, however the second body of air provided to the air chamber for breathing can be further filtered to remove more than 95% of particles.

It should be noted that the same numerical references refer to similar elements. Furthermore, for the sake of simplicity and clarity, and to not unduly burden figures with several reference numbers, not all figures contain references to all components and features, and references to some components and features may be found in only one figure, and components and features of the present disclosure which are illustrated in other figures can be easily inferred therefrom. The embodiments, geometrical configurations, materials mentioned, and/or dimensions shown in the figures are optional, and are given for exemplification purposes only. Therefore, the descriptions, examples, methods, and materials presented herein are not to be construed as limiting but rather as illustrative only.

In the present description, an embodiment is an example or implementation of the invention. The various appearances of “one aspect”, “one embodiment,” “an embodiment”, “some embodiments” or “some implementations” do not necessarily all refer to the same implementation. Although various features of the invention may be described in the context of a single embodiment, the features may also be provided separately or in any suitable combination. Conversely, although the invention may be described herein in the context of separate implementations for clarity, the invention may also be implemented in a single embodiment.

It should also be noted that various features and implementations of the facial mask assemblies described herein may be combined with any other features and implementations that are described herein. For example, various features described in relation to the facial mask assembly including a gap between a main hull and an outer hull can be adapted or combine to any feature described in relation to the facial mask assembly including multiple channels embedded in the main hull, unless two features are incompatible.

### EXPERIMENTATION RESULTS

Numerical simulations were performed to model airflow patterns inside and outside of the facial mask assembly. The software used for these simulations is Comsol Multiphysics. The simulations were achieved in a confined environment of approximately 3 cubic meter with an adult face. The simulation consists of exposing an adult face wearing the facial mask, to a sneeze airflow with a maximum velocity of more than 300 km/h, which is two times larger than estimated adult sneeze velocity. The adult wearing the facial mask is exhaling air with a flow rate of 10 L/min which is similar to the maximum exhalation flow rate of an adult. The two-airflow shield is created with a flow rate of 10 L/min.

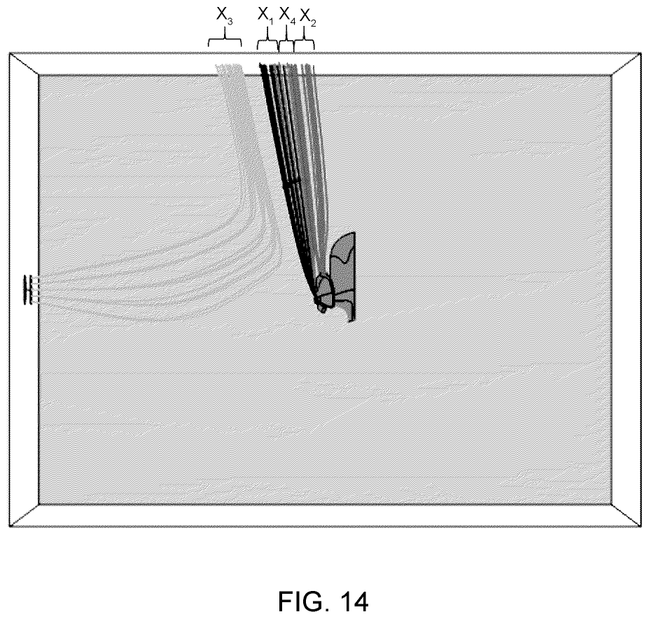

Referring to FIG. 14, simulation results show the external airflow (X3) of a person sneezing far from a user three feet away and the effect of the two laminar airflow shields. The created laminar airflow shields (X1) and (X2) acts as a two-airflow shield that is able to deflect the external airflow (X3) (sneeze airflow or other) and the exhaled airflow (X4) upwardly and away from the surrounding environment.

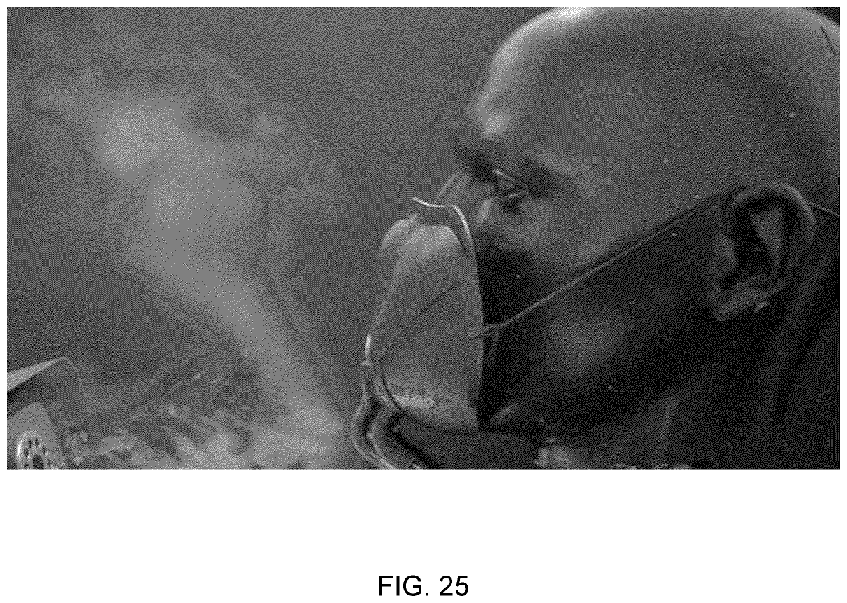

Another experimental setup was used to validate efficiency of the deflecting air path in the facial mask assembly. A vapour source with a flow rate of more than 25 L/min was used as a source of contaminated flow which was blown to a mannequin head wearing a single hull facial mask assembly and placed less than one feet away. FIG. 25 shows results when using an external compressed air tank to provide three bodies of air and create the two-airflow shield with an average air flow of 10 L/min. Experimental images were treated with a Matlab software.

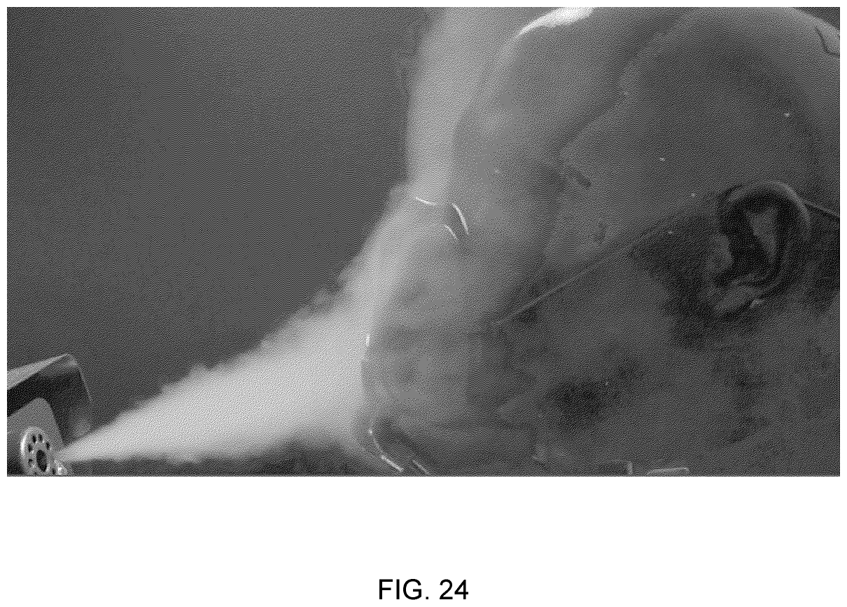

FIG. 24 shows the mannequin head exposed to the vapour without activating the airflow shields, while FIG. 25 shows the external vapors directed away from the face of the mannequin when the facial mask assembly is producing the two-airflow shield.

1. A facial mask assembly positionable to cover naso-buccal passages, the facial mask assembly defining:
a deflecting air path receiving a first body of air, and the deflecting air path being configured to convert the first body of air into a laminar airflow, thereby forming an air shield to uncovered face regions; and
an air chamber in fluid communication with the naso-buccal passages and being supplied with a second body of air.

2. The facial mask assembly of claim 1, comprising:
a main hull positionable to cover the naso-buccal passages, the main hull comprising:
a main component having a cup-like shape and defining the air chamber in fluid communication with the naso-buccal passages, and
a deflecting lip extending outwardly from an end portion of the main component and being tapered at a given angle;
an inlet unit comprising:
a first air inlet in fluid communication with the deflecting lip to provide the first body of air thereto at a first inlet flowrate, and
a second air inlet in fluid communication with the air chamber to provide the second body of air therein for supply to the naso-buccal passages at a second inlet flowrate; and
an outlet unit comprising an air outlet defined in the main hull and being in fluid communication with the air chamber to expel air from the air chamber;
wherein the first body of air being communicated to the deflecting lip is further converted into the laminar airflow upon being deflected at the given angle by the deflecting lip, the laminar airflow flowing away from the deflecting lip to form an air shield to the uncovered face regions, and wherein the first body of air is fed via the first air inlet at the first inlet flowrate that is adjusted to provide a laminar flowrate being optionally of at least 0.1 L/min.

3. The facial mask assembly of claim 2, wherein the deflecting lip extends from at least one of:
an upper end region of the main component so that the resulting laminar airflow protects at least an ocular region of the uncovered face regions;
a side end region of the main component so that the resulting laminar airflow protects an auricular region of the uncovered face regions; or
a lower end region of the main component so that the resulting laminar airflow protects a cervical region of the uncovered face regions.

4. (canceled)

5. (canceled)

6. The facial mask assembly of claim 2, wherein the deflecting lip is defined by multiple lip portions, each lip portion being tapered differently from an adjacent lip portion.

7. The facial mask assembly of claim 2, further comprising an outer hull providing coverage to the main hull and operatively connected to the main component of the main hull to define a gap there between, and wherein the first body of air is supplied to the gap via the first air inlet and further flows along the gap to the deflecting lip to generate the laminar airflow.

8. (canceled)

9. (canceled)

10. The facial mask assembly of claim 7, further including an adjustment mechanism allowing the outer hull to move with respect to the main hull so as to vary the width of the gap.

11-13. (canceled)

14. The facial mask assembly of claim 7, wherein the outlet unit further comprises:
an outer air outlet being defined as at least one aperture in the outer hull;
wherein the air outlet is in fluid communication with the outlet air outlet to expel air from the air chamber.

15. The facial mask assembly of claim 14, wherein the main hull further comprises a protrusion extending inwardly from the main component of the main hull and towards the naso-buccal passages to define a cavity, and wherein the air outlet of the main hull comprises multiple inner apertures defined in a proximal surface of the protrusion.

16-18. (canceled)

19. The facial mask assembly of claim 7, wherein the first air inlet is a first aperture defined in a lower region of the outer hull to feed the first body of air to the gap between the main hull and the outer hull; and the second inlet is a second aperture defined in a lower region of the main hull to feed the second body of air to the air chamber.

20. The facial mask assembly of claim 2, wherein the main hull is configured to define multiple hollow channels extending within the main hull from the first air inlet to a base of the deflecting lip for guiding the first body of air.

21. (canceled)

22. The facial mask assembly of claim 20, wherein the first air inlet is a first aperture defined in a lower region of the main hull to feed the first body of air to the multiple channels; and the second inlet is a second aperture defined in the lower region of the main hull to feed the second body of air to the air chamber.

23. The facial mask assembly of claim 2, wherein the inlet unit further comprises:
a first tubular connector that is connected to the first air inlet; and
a second tubular connector that is connected to the second air inlet;
wherein the first tubular connector and the second tubular connector are connectable to the air source to provide the first body of air and second body of air respectively.

24. (canceled)

25. (canceled)

26. The facial mask assembly of claim 2, further comprising multiple blowing chambers that are distributed over a surface of the main hull, each blowing chamber having an outlet located proximal to a base of the deflecting lip and having an inlet encasing a fan that is actuable to make a portion of the first body of air flow through the blowing chamber at the first inlet flowrate.

27. (canceled)

28. The facial mask assembly of claim 2, further comprising a controller unit to adjust at least one of the first inlet flowrate and the second inlet flowrate.

29. (canceled)

30. The facial mask assembly of claim 2, wherein the second inlet flowrate is lower than the first inlet flowrate.

31. The facial mask assembly of claim 2, further comprising a sealing member that is secured to a circumference of the main hull and ensuring sealing of the air chamber when the main hull is positioned to cover the naso-buccal passages.

32. (canceled)

33. (canceled)

34. The facial mask assembly of claim 2, further comprising a flow control component that is operatively connected to the main hull and located within the air chamber to create a local flow resistance to the incoming second body of air in a lower region of the air chamber, thereby guiding the second body of air mainly towards nasal passages.

35-38. (canceled)

39. The facial mask assembly of claim 2, wherein the inlet unit further comprises a filtering membrane to remove contaminants from at least one of the first body of air and the second body of air.

40. (canceled)

41. (canceled)

42. The facial mask assembly of claim 2, further comprising a deflection wall that extends outwardly and upwardly to convert a third body of air into a secondary laminar airflow along an upper region of the facial mask assembly, thereby directing air expelled from the air chamber between two laminar airflows.

43-46. (canceled)

47. The facial mask assembly of claim 2, wherein the outlet unit further comprises a one-way valve allowing air from the air chamber to be expelled towards the outside of the mask assembly via the at least one air outlet, and preventing air from entering the air chamber via the at least one air outlet.

48-64. (canceled)
